(19) United States
(12) Patent Application Publication
(10) Pub. No.: US 2026/0199812 A1
(43) Pub. Date: Jul. 16, 2026

(54) SCREENING DEVICE, METHOD FOR DETECTING A SAG OF AN ENDLESS DRIVE ELEMENT, AND USE OF A POSITION SENSOR

(71) Applicant: HUBER SE, Berching (DE)

(72) Inventor: Andreas BECK, Neumarkt (DE)

(21) Appl. No.: 19/448,328

(22) Filed: Jan. 14, 2026

(30) Foreign Application Priority Data
Jan. 15, 2025 (DE) 10 2025 101 297.0

(51) Int. Cl. B01D 33/15; B01D 33/80

(52) U.S. Cl. CPC B01D 33/15; B01D 33/804

(57) ABSTRACT

In one aspect, a screening device for separating out and removing debris from wastewater includes at least one endless drive element which is movable on a circulating path by means of at least one drive motor of the screening device during the operation of the screening device.

### CROSS-REFERENCE TO RELATED APPLICATIONS

The present application is based upon and claims the right of priority to German Patent Application No. 10 2025 101 297.0, filed Jan. 15, 2025, the disclosure of which is hereby incorporated by reference herein in its entirety for all purposes.

### FIELD OF THE INVENTION

The present subject matter relates to a screening device for separating out and removing debris from wastewater, wherein the screening device includes at least one endless drive element, which is movable on a circulating path by means of at least one drive motor of the screening device during the operation of the screening device. Furthermore, the present subject matter also relates to a method for detecting a sag of an endless drive element of a screening device of this type and to the use of a position sensor for detecting a sag of an endless drive element of a screening device.

### BACKGROUND OF THE INVENTION

Relevant screening devices are sufficiently known from the related art and are used, for example, to remove coarse screenings (wood, stones, etc.) from wastewater flowing in a sewer. For this purpose, the screening device is generally integrated into the sewer in such a way that the screening surface extends perpendicularly or at a slight slant upward from the channel bed. In order to enable the screenings retained by the bar screen forming the screening surface to be discharged, the screening surface usually extends above the maximum water level to be expected.

Due to a circulating operation of clearing elements in the form of cleaning rakes associated with the screen surface, the screenings are conveyed upward, along the front side of the screen surface, in the direction of a discharge. From there, the screenings are removed from the cleaning rake or cleaning rakes, for example, by means of a scraper. In order to be able to move the cleaning rakes, relevant screening devices include a drive motor, which is connected, for example, to two drive elements extending adjacent to each other, wherein the drive elements in turn are connected to the individual cleaning rakes. If the drive elements are moved on a predefined circulating path by means of the drive motor, the cleaning rakes also move on this circulating path and thus along the bar screen.

Such a screening device of the type in question is disclosed, for example, in DE 10 2020 116 332 A1. This document deals with a detection and closed-loop control of the tensile stress of the drive elements. Due to the tensile forces acting on the drive elements, they stretch over time, whereby, in the extreme case, operational disruptions such as slip between the drive elements and the drive motor can occur. To solve this problem, DE 10 2020 116 332 A1 proposes adjusting the tension by means of a current consumption of the drive motor increasing in a known manner as the tension increases. However, the energy consumption of the drive motor, in addition to the tensile stress, can also depend on other factors such as the number of accumulating screenings. These methods for detecting the tensile stress of drive elements are therefore susceptible to error. The present subject matter is also based on the knowledge that a dangerously low tensile stress of a drive element is expressed as a sag of this drive element. Therefore, a screening device that allows for reliable detection of the sag of the drive element would be welcomed in the art.

### SUMMARY OF THE INVENTION

In various aspects, the problem addressed by the present subject matter relates to improving known screening devices in such a way that a sag of a drive element is detectable in a simple and accurate manner.

In various aspects, the problem is solved by a screening device, a method, and a use having the features described and/or claimed herein.

In one aspect, the present subject matter relates to the screening device for separating out and removing debris from wastewater including at least one endless drive element, which is movable on a circulating path by means of at least one drive motor of the screening device during the operation of the screening device.

The drive element is preferably connected to individual cleaning rakes or individual screening elements, wherein the drive element moves either the cleaning rakes or the screening elements, depending on the design of the screening device.

The drive element is, for example, a drive chain or a drive belt. The cleaning rakes or the screening elements may also be connected via connecting elements, for example joints. In this case, the connecting elements can be operatively connected to the drive motor, so that a respective plurality of connecting elements can be considered as one drive element. Furthermore, the cleaning rakes or screening elements may include, in addition to the connecting elements, outwardly protruding bolts, which are then operatively connected to a respective drive wheel. A drive element is formed in this case by the connecting elements and the bolts, which are located on the same side of the cleaning rakes or screening elements.

Each drive element therefore preferably includes a plurality of individual elements, which are preferably movable in relation to each other and which jointly form the respective drive element, wherein individual elements or all individual elements can also be an integral part of individual cleaning rakes or screening elements.

The drive element is moved by means of at least one drive motor of the screening device. The drive element is preferably guided in a lower region and an upper region of the screening device, in each case by means of a deflection mechanism, in particular a drive wheel such as a sprocket (also referred to as: gear-wheel) or a smooth deflection curve, wherein one of the drive wheels in each case, preferably the upper drive wheel, is driven by means of the drive motor.

The screening device according to the present subject matter is distinguished by the fact that it includes a position sensor, by means of which a sag of the drive element is detectable. The position sensor makes it possible, for example, to continuously monitor the operating state of the drive element. As mentioned above, a sag of the drive element occurs when the tensile stress in the drive element decreases. This occurs, for example, due to wear, material fatigue, or overloading. The sag manifests itself in a change in position or shape of the drive element relative to a target position on the circulating path. To this end, the position sensor can measure, for example, the distance between the drive element and a positionally fixed reference point of the screening device.

The sensor-based detection of the sag makes it possible to re-tension in a timely manner or preventively replace the drive element. As a result, disturbances in the operating sequence and possible consequential damage to the screening device can be avoided.

The position sensor is preferably arranged at a position of the circulating path at which, by design, a sag is not to be expected, but the sag is clearly measurable if it arises, for example, due to wear. Due to gravity, this is the case, for example, in the region of a lower deflection of the drive element. The sensor can be connected, for example, to an evaluation unit, which generates a signal when a predetermined limit value for the sag is exceeded.

The position sensor is preferably a contactless operating sensor. In particular, optical or capacitive sensors are suitable for detecting the position of the drive element. The position sensor is designed in particular as a proximity sensor.

It is particularly advantageous, however, when the position sensor is designed as an inductive sensor. An inductive sensor is particularly suitable for detecting the sag of the drive element, since it operates in a contactless and thus wear-free manner. The inductive sensor generates an alternating electromagnetic field and detects changes in this field, which are induced by the position of the, in particular metal, drive element. The measurement is carried out regardless of optical ambient conditions such as contaminants, spray water, or darkness. This is of particular technical significance for the use in a screening device for wastewater.

The measurement principle of the inductive sensor is preferably based on a change in the inductance of a measurement coil when metal is located in the detection range of the sensor. For example, the distance between sensor and metal drive element correlates with the measured change in inductance. The inductive sensor can in particular be designed in such a way that it covers a measuring range of a few millimeters to multiple centimeters.

The output signals of the inductive sensor are preferably formed as analog voltage signals and/or current signals, which are proportional to the measured distance. These signals can be processed, for example, by an evaluation unit of the screening device.

It is also advantageous when the position sensor includes an active sensor element and at least one passive sensor element. The use of active and passive sensor elements makes it possible to particularly reliably detect the sag of the drive element. The active sensor element is preferably designed as a signal-generating unit, whereas the passive sensor element is used as a signal receiver or reflector. The two sensor elements form a cooperating measuring system.

When an inductive sensor is used, the active sensor element includes in particular an excitation coil, which generates an electromagnetic field. The passive sensor element can be designed, for example, as a metal resonator or as a receiving coil. The interaction between the active sensor element and passive sensor element is affected by the position of the drive element, whereby the sag is detectable.

It is particularly advantageous when the active sensor element is arranged on a static machine part of the screening device and the at least one passive sensor element is arranged on the drive element. The defined arrangement of the sensor elements ensures precise measurement of the sag, since the active sensor element forms a positionally fixed reference position. A static machine part within the scope of the present subject matter is in particular a component fixedly connected to the frame of the screening device, for example, a support, a console, a housing part, and/or the frame of the screening device.

Fastening the passive sensor element to the drive element makes it possible to directly detect the movement of the drive element. The fastening is carried out in particular by screwing, riveting, welding, bonding, and/or an interlocking insertion into receptacles in the drive element provided therefor.

In an embodiment as an inductive sensor system, this arrangement allows a particularly accurate distance measurement, since the passive sensor element fastened to the drive element is always in the optimal detection range of the active sensor element when the drive element assumes its target position. A deviation from this position due to a sag results in a defined change in the measurement signal.

It is advantageous when the active sensor element is arranged in the region of a slack side of the drive element. “Slack side” refers to the portion of the drive element that is located on the return path of the circulating path and is not actively involved in the transport of debris. In this region, the drive element is particularly susceptible to sagging, since the lowest tensile stress typically prevails here.

The arrangement of the active sensor element in the region of the slack side allows particularly early detection of critical operating states. This is due to the fact that a loss of tension of the drive element occurs in the slack side first, before it affects the load-carrying part of the circulating path.

It is also advantageous when the at least one passive sensor element is designed as a sensor flag, which includes in particular a surface having at least one cutout. A sensor flag within the scope of the present subject matter is in particular a planar component, which is preferably made of a metallic material. The embodiment of the passive sensor element as a sensor flag allows a particularly cost-effective and robust design. The sensor flag can be, for example, punched from a metal sheet or manufactured by machining.

The cutout provided in the surface of the sensor flag is used to affect the electromagnetic field generated by the active sensor element in a targeted manner. Due to the cutout, in particular, a characteristic change in the measurement signal is brought about when the sensor flag moves past the active sensor element. The cutout can be designed, for example, in the form of an elongate hole, a circular opening, or a more complex geometric shape. In particular, the sensor flag can have an annular contour, wherein a signal is triggered in the active sensor element when a part of this annular contour passes by the active sensor element.

The surface of the sensor flag is preferably dimensioned in such a way that it completely covers the detection region of the active sensor element. The sensor flag can in particular be fastened to a chain link or a connecting tab of the drive element. Due to the integration of the sensor flag into the drive element, reliable position detection is ensured under harsh operating conditions.

In this context, it is particularly advantageous when the drive element includes rollers and connecting elements arranged between the rollers, wherein the at least one passive sensor element is arranged on one of the connecting elements. The drive element is designed in particular as a roller chain in this embodiment. The rollers are used for force transmission and guidance of the drive element on the circulating path. The connecting elements are preferably designed as chain links which hingedly connect the adjacent rollers to one another. This design allows the drive element to be flexible and, at the same time, tension-resistant.

The arrangement of the passive sensor element on a connecting element utilizes the existing installation space of the chain design in an advantageous manner. The connecting element offers in particular a possibility for fastening the passive sensor element in a stable manner, since it is fixedly connected to the force-transmitting components of the chain. As a result, the position of the passive sensor element relative to the drive element remains constant even under a load effect.

The passive sensor element can be connected to the connecting element, for example, by means of a screw connection or riveting. Preferably, the passive sensor element is fastened to the connecting element in such a way that it projects radially outwards over the contour of the roller chain. This ensures a defined distance from the active sensor element and avoids disturbing influences by other components of the drive element on the measurement.

It is particularly advantageous when the position sensor includes at least two passive sensor elements. The use of at least two passive sensor elements allows redundant detection of the sag of the drive element. The passive sensor elements are preferably arranged on the drive element at a defined distance from one another. This distance can correspond, for example, to a whole-number multiple of the spacing of the drive element.

Due to the arrangement of multiple passive sensor elements, a higher measurement frequency is achieved, since more measurement signals are generated at equal time intervals. This makes it possible, for example, to monitor the sag in a quasi-continuous manner. The time sequence of the measurement signals from the different passive sensor elements also permits inferences to be drawn regarding the movement speed of the drive element.

The passive sensor elements can in particular be identically designed in order to keep the number of different components to a minimum. The number and distribution of the passive sensor elements on the periphery of the drive element can be selected, for example, in such a way that at least one of the passive sensor elements is in the detection range of the active sensor element at any point in time. This ensures seamless monitoring of the operating state.

It is advantageous when the screening device includes a plurality of drive elements, wherein at least one position sensor is provided for each drive element. Equipping multiple drive elements with at least one position sensor each makes it possible to comprehensively monitor the operating state of the overall screening device. The drive elements are preferably arranged in parallel to one another and can be synchronously driven, for example, via a common drive shaft. In particular, the screening device has two circulating paths extending in parallel to each other, on which the drive elements are moved during the operation of the screening device (the circulating paths do not need to be physically present; rather, the circulating paths refer to the path taken by the drive elements as they move).

The separate detection of the sag of each individual drive element is of particular technical significance, since the drive elements can stretch to different extents during operation. This can be due, for example, to a non-uniform load distribution or local signs of wear. The individual monitoring allows the early detection of asymmetrical operating states, which could result in a tilt of the cleaning elements moved by the drive elements.

The position sensors of the different drive elements are preferably identically designed and arranged at geometrically corresponding positions of the circulating paths. The sensor signals can be processed in particular by a common evaluation unit which makes it possible to compare the sags of the different drive elements. The evaluation unit can be designed, for example, in such a way that it takes into account different limit values for the individual drive elements.

It is also advantageous when the position sensor is water-tight, in particular according to the IP68 rating. The water-tight design of the position sensor is of particular technical relevance for use in a screening device for wastewater. The IP68 rating describes, according to the IEC 60529 standard, the highest level of protection against the ingress of dust and protection against continuous water immersion under defined pressure and time conditions.

The water-tight position sensor is preferably accommodated in a hermetically sealed housing. The seal can be implemented, for example, by means of O-rings, sealing sleeves, or sealed feedthroughs. The housing is made, in particular, of corrosion-resistant material, for example stainless steel or high-quality plastic. An electrical connection of the sensor to an evaluation unit is established preferably via water-tight plug connectors or securely encapsulated cable connections.

The method according to the present subject matter is suitable for detecting a sag of an endless drive element of a screening device. The screening device is used, in particular, to separate out and remove debris from wastewater. In the method, the drive element is moved on a circulating path during the operation of the screening device by means of at least one drive motor of the screening device. The method is distinguished by the fact that a position of the drive element is detected by means of a position sensor. The method allows, for example, a process-integrated monitoring of the operating state of the drive element during the normal function of the screening device. The position is detected, in particular, without intervening in the cleaning process and without interrupting the operation of the screening device.

The position of the drive element is preferably detected continuously or at regular time intervals. The position sensor generates in particular an electrical signal which is a measure of the distance between a positionally fixed reference point and the drive element. A deviation of the detected position from a specified target position is an indicator of the sag of the drive element.

The position is detected, for example, by measuring the change in inductance of a measurement coil when the drive element moves through its electromagnetic field. The measuring method can in particular be designed in such a way that, in addition to the pure position detection, the movement speed of the drive element can also be determined based on the change in the measurement signal over time.

The collected position data can be processed preferably in an evaluation unit of the screening device. The method makes it possible to form trend signals, which permit preventive maintenance of the drive element. The evaluation can also include, for example, a comparison with reference data which characterize the normal state of the drive element.

It is particularly advantageous when a signal from the position sensor is evaluated only during a control run of the drive element. A control run within the scope of the present subject matter is in particular a defined motion sequence of the drive element, which is carried out under controlled conditions. The limitation of the signal evaluation to the control run increases the reliability of the measurement, since disturbing influences from the regular operation are minimized. The control run can be carried out, for example, during the start-up of the system, at regular maintenance intervals, or if increased wear is suspected.

During the control run, the drive element is moved in particular through at least one complete revolution in order to detect the sag over the entire length of the drive element. The measured values can be compared with reference values which have been recorded under defined conditions, for example during the initial start-up or after maintenance. The evaluation of the sensor signals during the control run can preferably also include a plausibility check of the measured values. A control run can be triggered, for example, manually by an operator of the screening device or carried out in an automated manner, for example, at certain time intervals.

It is advantageous when a circulating direction of the drive element during the control run is opposite a normal operation of the screening device. The reversal of the circulating direction during the control run allows a particularly meaningful detection of the sag, since the sag possibly appears more clearly here and thus can be better detected by means of a measurement.

The reversed movement direction results in a rearrangement of forces in the drive element, whereby, in particular, signs of wear and material fatigue become more clearly detectable. During the backward movement, the position sensor detects, in particular, the maximum deflection of the drive element, which is better detectable by measurement due to the reversal of the movement direction.

The method can preferably be carried out in such a way that a measurement is initially carried out in the normal operating mode and then a comparative measurement is carried out in the opposite running direction. The difference between the measured values delivers additional information on the state of wear of the drive element.

It is also advantageous when a circulating speed of the drive element during the control run is slower than during normal operation of the screening device. The reduced circulating speed during the control run makes it possible to more precisely detect the position of the drive element. At a lower speed, fewer dynamic effects occur, such as vibrations, oscillating movements, or speed-dependent deformations, which could affect the measurement result. The speed during the control run is preferably between 10% and 50% of the normal speed.

A slower movement of the drive element also results in a higher spatial resolution of the measurement, since the position sensor can detect more measurement points per distance. This is advantageous in particular when passive sensor elements are used, wherein the passive sensor elements are mounted on the drive element. The reduced speed allows for a longer dwell time of the passive sensor elements in the detection range of the active sensor element.

The speed is reduced preferably by means of a closed-loop control of the drive motor. The motor can be operated, for example, via a frequency converter, which allows a continuously variable adjustment of the speed. The detection of the measured values can be synchronized with the motor control in order to ensure that the measured values are associated with certain positions of the drive element in a defined manner.

It is also extremely advantageous when an extent of the sag is determined by the position sensor being triggered multiple times. The shape, for example, of a passive sensor element can be designed in such a way that, depending on the sag, a plurality of active regions of the passive sensor element pass by an active sensor element. A contour of the passive sensor element can have, for example, a plurality of protrusions, cutouts, or interruptions, each of which brings about a trigger signal from the sensor.

Thus, in the case of a slight sag, for example, a sensor signal is triggered once. In the case of a greater sag, the signal is triggered twice when the passive sensor element is passed by. When the sag is even greater, the number of signals can continue to increase.

The present subject matter also relates to the use of a position sensor to detect a sag of an endless drive element of a screening device, which is used to separate out and remove debris from wastewater. The screening device is designed in particular according to the preceding description. The use of a position sensor for sag detection is a new technical use of a position sensor in the area of wastewater treatment. The position sensor is used in an environment which is characterized by aggressive media, high humidity, and strong mechanical loads. The use makes it possible, for example, to continuously monitor the state of the drive element during the operation of the screening device.

The position sensor that is used is preferably designed for continuous use in the described environment. This is achieved in particular by means of water-tight encapsulation and corrosion-resistant materials. The sensor system can operate, for example, according to the principle of electromagnetic induction, whereby a contactless and thus wear-free detection of the sag is made possible.

The use of the position sensor makes possible a new type of preventive maintenance of screening devices. Due to the permanent monitoring of the drive element, signs of wear can be detected early, before functional impairments or failures occur. The measurement signals of the sensor can preferably be incorporated into a higher-level process control system, which makes it possible to monitor a plurality of screening devices in an automated manner. The position sensor can in particular be used in such a way that continuous measurements can be carried out during normal operation and specific control measurements can be carried out during maintenance runs.

### BRIEF DESCRIPTION OF THE FIGURES

Further advantages of the present subject matter are described in the following exemplary embodiments, wherein:

FIG. 1 shows a schematic side view of the screening device according to the present subject matter,

FIG. 2 shows an enlarged schematic side view of the screening device in the region of a deflection of a drive element without sag,

FIG. 3 shows an enlarged schematic side view of the screening device in the region of the deflection of the drive element with slight sag, and

FIG. 4 shows an enlarged schematic side view of the screening device in the region of the deflection of the drive element with great sag.

### DETAILED DESCRIPTION

In the following description of the figures, the same reference characters are used for features that are identical and/or at least comparable in each of the different figures. The individual features, their embodiment and/or mode of operation are explained in detail usually only upon the first mention thereof. If individual features are not explained in detail once more, their embodiment and/or mode of operation corresponds to the embodiment and mode of operation of the previously described identically-acting or identically-named features.

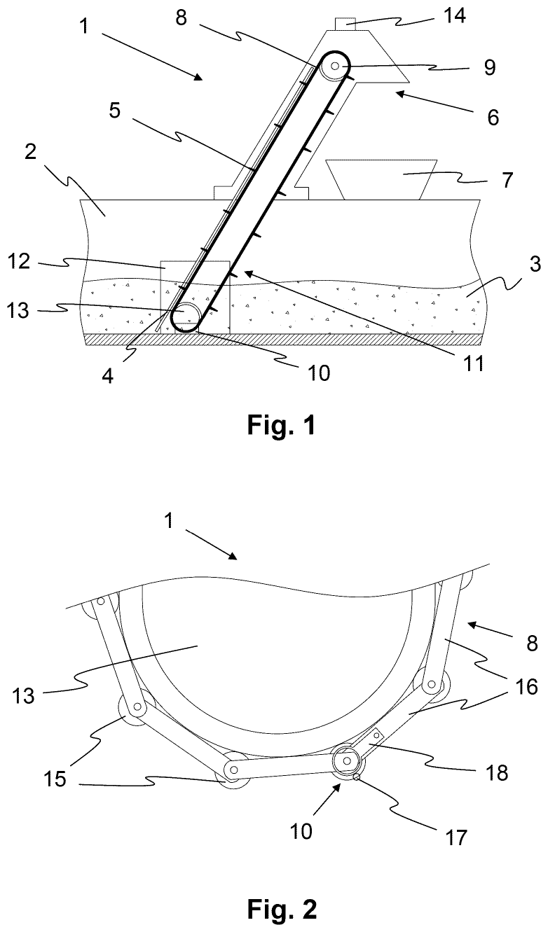

FIG. 1 shows a schematic side view of a screening device 1, which is used to clean wastewater 3. The screening device 1 is installed in a sewer 2, wherein a bar screen 4 is arranged, for example, transversely to the flow direction of the wastewater 3. The bar screen 4 retains coarse debris contained in the wastewater 3, whereas the clarified wastewater 3 can pass through the bar screen 4.

The retained debris is removed by means of a plurality of cleaning rakes 5, which are set into motion by means of an endless drive element 8. The cleaning rakes 5 engage, for example, into the bar screen 4 and carry along the debris collected there. In particular, the cleaning rakes 5 are set into motion by means of bilaterally arranged drive elements 8. The drive element 8 or the drive elements 8 is/are driven by a drive motor 9 and are guided over a lower deflection mechanism 13. The debris transported upward by the cleaning rakes 5 is directed, for example via a screenings discharge 6, into a container 7, where it is collected.

In the lower region of the screening device 1, the drive element 8 forms a slack side 11, which is particularly susceptible to sagging, since the lowest tensile stress in the drive element 8 prevails here. A position sensor 10, which is used to detect the sag of the drive element 8, is arranged in particular in this critical region. The position sensor 10 is preferably designed as an inductive sensor and is arranged on a static machine part 12 of the screening device 1.

The arrangement of the position sensor 10 in the region of the slack side 11 is particularly advantageous, since even slight changes in the tensile stress here result in measurable changes in position of the drive element 8. The position sensor 10 can, for example, continuously detect the distance between the drive element 8 and the static machine part 12. An increase in this distance is a direct indicator of an increasing sag of the drive element 8.

The detected measured values are transmitted, for example, to an evaluation unit 14. In particular, the evaluation unit 14 processes the signals from the position sensor 10 and can generate corresponding warning signals when defined limit values are exceeded.

The arrangement shown in FIG. 1 ensures that the drive element 8 is reliably monitored during the operation of the screening device 1. The installation position of the bar screen 4, which is oblique in this exemplary embodiment, sup-ports the removal of the debris, since the debris slides due to gravity to the lower end of the bar screen 4, where it is captured by the cleaning rakes 5. Other arrangements of the bar screen 4, of the drive elements 8, and of the cleaning rakes 5 are also possible.

FIG. 2 shows an enlarged schematic representation of a portion of the screening device 1 in the region of the deflection mechanism 13, wherein the drive element 8 is shown in a properly tensioned state without sag.

The drive element 8 in this exemplary embodiment is designed as a roller chain and includes a plurality of rollers 15, which are hingedly connected to one another by connecting elements 16. This design allows the drive element 8 to be flexible and, at the same time, tension-resistant. Greater forces can also be transmitted with low friction of the drive element 8. The rollers 15 are used for force transmission and precise guidance of the drive element 8 about the deflection mechanism 13.

The position sensor 10, which includes an active sensor element 17 and a passive sensor element 18 in this exemplary embodiment, is arranged in the region shown. The active sensor element 17 is arranged in particular on the static machine part 12, which is not shown here. The active sensor element 17 is preferably designed as an inductive sensor with an excitation coil and generates an electromagnetic field for position detection. The passive sensor element 18 is fastened to a connecting element 16 of the drive element 8 and moves there-with.

The fastening of the passive sensor element 18 to the connecting element 16 is particularly advantageous, since the connecting elements 16 offer a stable mounting option and, at the same time, the position of the passive sensor element 18 relative to the drive element 8 remains constant even under a load effect. The passive sensor element 18 is arranged on the connecting element 16, for example, in such a way that it projects radially outwards over the contour of the roller chain, whereby a defined distance to the active sensor element 17 is ensured.

The active sensor element 17 and the passive sensor element 18 are arranged in particular in such a way that, in the represented situation without sag, a signal from the position sensor 10 is not currently triggered. This constellation represents the reference state, proceeding from which deviations due to sag can be detected. The rollers 15 of the drive element 8 are uniformly spaced apart, whereby a similar movement about the deflection mechanism 13 is made possible.

The arrangement shown makes it possible to precisely detect the position of the drive element 8, since the passive sensor element 18 passes through the detection range of the active sensor element 17 during every revolution of the drive element 8. Due to the regular detection of the position, changes in the running behavior of the drive element 8 can be detected early.

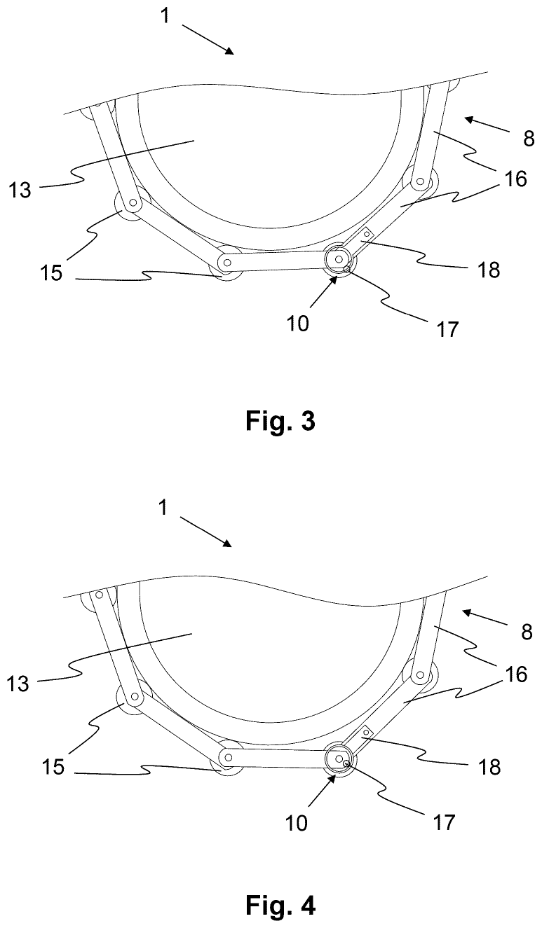

FIG. 3 shows the same portion of the screening device 1 as FIG. 2, although in an operating state in which the drive element 8 has a slight sag. This sag manifests itself in a changed position of the drive element 8 in comparison to the reference state from FIG. 2.

The position sensor 10 detects this change based on the relative motion between the active sensor element 17 and the passive sensor element 18. The active sensor element 17 and the passive sensor element 18 are arranged in particular in such a way that, in the represented situation with slight sag, the position sensor 10 is triggered precisely once during a revolution of the drive element 8.

The represented situation shows an early state of wear of the drive element 8, in which the sag is still in the tolerable range. The early detection of such signs of wear is of particular technical relevance, since it makes preventive maintenance possible. The position of the active sensor element 17 is selected in such a way that even slight changes in position of the drive element 8 can be reliably detected.

FIG. 4 shows the same portion of the screening device 1 as FIGS. 2 and 3, although in an operating state with a strongly pronounced sag of the drive element 8. This state represents a critical state of wear in which the functional reliability of the screening device 1 is jeopardized.

The sag of the drive element 8, which is clearly enlarged in comparison to FIG. 3, is recognizable by the considerable lowering of the rollers 15 and connecting elements 16. The position of the drive element 8 deviates significantly from the target position, which indicates, for example, excessive wear and a correspondingly reduced tensile stress. The distance between the rollers 15 and the deflection mechanism 13 has clearly increased with respect to the normal state from FIG. 2.

In this exemplary embodiment, the contour of the passive sensor element 18, which is designed as a sensor flag, is particularly relevant. The passive sensor element 18 has an annular contour, which results in a sensor signal from the position sensor 10 being triggered twice, for example, when there is an increased sag of the drive element 8 during one revolution or one pass of the passive sensor element 18 by the active sensor element 17. The drive element 8 moves due to the increased sag in particular in such a way that the active sensor element 17 initially enters the annular contour of the passive sensor element 18 and thus the first signal is generated. Due to the continuous movement of the drive element 8, the active sensor element 17 then exits the annular contour once more, whereby the second sensor signal is triggered. As a result, an extent of the sag of the drive element 8 can be determined in a simple way.

The represented situation illustrates the need for immediate maintenance of the drive element 8. The pronounced sag can result in different operational disruptions, such as a non-uniform movement of the drive element 8, increased wear of the rollers 15 and connecting elements 16, reduced effectiveness of the cleaning rakes 5, and/or a possible jump of the drive element 8 on the deflection mechanism 13 or on the drive motor 9. The cooperation of the active sensor element 17 and the passive sensor element 18 makes it possible to reliably detect such critical operating states.

### LIST OF REFERENCE CHARACTERS

1 screening device
2 sewer
3 wastewater
4 bar screen
5 cleaning rake
6 screenings discharge
7 container
8 drive element
9 drive motor
10 position sensor
11 slack side
12 machine part
13 deflection mechanism
14 evaluation unit
15 roller
16 connecting element
17 active sensor element
18 passive sensor element

1-16. (canceled)

17. A screening device for separating out and removing debris from wastewater, the screening device comprising:
at least one drive motor,
at least one endless drive element configured to be movable on a circulating path by the at least one drive motor during an operation of the screening device, and
a position sensor configured to detect a sag of the at least one endless drive element.

18. The screening device of claim 17, wherein the position sensor is an inductive sensor.

19. The screening device of claim 17, wherein the position sensor includes an active sensor element and at least one passive sensor element.

20. The screening device of claim 19, wherein the active sensor element is arranged on a static machine part of the screening device and the at least one passive sensor element is arranged on the at least one endless drive element.

21. The screening device of claim 19, wherein the active sensor element is arranged in a region of a slack side of the at least one endless drive element.

22. The screening device of claim 19, wherein the at least one passive sensor element is configured as a sensor flag, which includes a surface having at least one cutout.

23. The screening device of claim 19, wherein the at least one endless drive element includes rollers and connecting elements arranged between the rollers, wherein the at least one passive sensor element is arranged on one of the connecting elements.

24. The screening device of claim 19, wherein the position sensor includes at least two passive sensor elements.

25. The screening device of claim 17, wherein the screening device includes a plurality of endless drive elements, and, wherein at least one position sensor is provided for each of the plurality of endless drive elements.

26. The screening device of claim 17, wherein the position sensor is water-tight according to an IP68 rating.

27. A method for detecting a sag of an endless drive element of a screening device which is used to separate out and remove debris from wastewater, the method comprising:
moving the endless drive element on a circulating path by at least one drive motor of the screening device during an operation of the screening device, and d
etecting a position of the endless drive element by a position sensor.

28. The method of claim 27, wherein a signal from the position sensor is evaluated only during a control run of the endless drive element.

29. The method of claim 28, wherein a circulating direction of the endless drive element during the control run is opposite from a normal operation of the screening device.

30. The method of claim 28, wherein a circulating speed of the endless drive element during the control run is slower than during a normal operation of the screening device.

31. The method of claim 27, wherein an extent of the sag of the endless drive element is determined by the position sensor being triggered multiple times.
